(19) United States
(12) Patent Application Publication
(10) Pub. No.: US 2012/0219731 A1
(43) Pub. Date: Aug. 30, 2012

(54) Deer Antler Mounting Kit

(76) Inventor: Jon Travis Paragamian, Coeur d'Alene, ID (US)

(21) Appl. No.: 13/035,801

(22) Filed: Feb. 25, 2011

(51) Int. Cl. B44C 5/02

(52) U.S. Cl. 428/16

(57) ABSTRACT

A deer antler mounting kit adapted to be employed by a hunter to affixably mount upon the provided plaque for display, an antler and skull piece thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a deer mounting kit for use by a hunter/sportsman mounting their antlers for display.

When a hunter is skilled and fortunate enough to harvest an antlered deer, and they wish to display the same, their choices are to either have a professional taxidermist do a head mount or European mount or for the hunter themselves to buy generic shaped plaques and mount their antlers on said plaque.

Throughout the past, hunters have always used standard plaque shapes to attach their deer antlers. Many plaques and kits exist for mounting antlers to but there are none in the shape of the actual deer head in which the antlers are mounted to resemble the deer head.

Although there are kits for mounting of antler trophies and the like, such as exemplified in U.S. Pat. No. 4,464,400 to Dotzman dated Aug. 7, 1984, and U.S. Pat. No. 4,717,626 to Bedger dated Jan. 5, 1988 there are no other known methods or kits such as that herein taught for the mounting for display of a deer antler and skull piece on a plaque in the shape of a deer head silhouette.

### BRIEF SUMMARY OF THE INVENTION

It is the principal object of the present invention to provide a deer antler mounting kit comprised of a plaque for mounting deer antlers and skull piece.

It is also an object of the present invention to provide a deer antler mounting kit adapted to accommodate the mounting for display of the antlers and skull piece of various size and type of wild deer antlers.

It is a further object of the present invention to provide a deer antler mounting kit which embodies a mounting plaque indicative of a deer head.

It is another object of the present invention to provide a deer antler mounting kit which is economical yet an attractive means for mounting for display deer antlers and skull piece.

Still another object of the present invention is to provide a deer antler mounting kit capable of being advantageously employed by one not possessed of any particular or specialized skills.

The foregoing objects and other features and advantages of the present invention will be readily evident upon a study of the following specification when taken in conjunction with the accompanying drawings comprising a part thereof.

### BRIEF DESCRIPTION OF THE SEVERAL VIEWS OF THE DRAWING

FIG. 1 is a front elevation view of an assembled deer antler mounting kit with antlers and skull piece mountably affixed thereto for display.

FIG. 2 is an exploded perspective elevation view of the plaque portion of the deer antler mounting kit of present invention, illustrating therein the manner of assembly of an exemplary antlers and skull piece thereto for display.

### DETAILED DESCRIPTION OF THE INVENTION

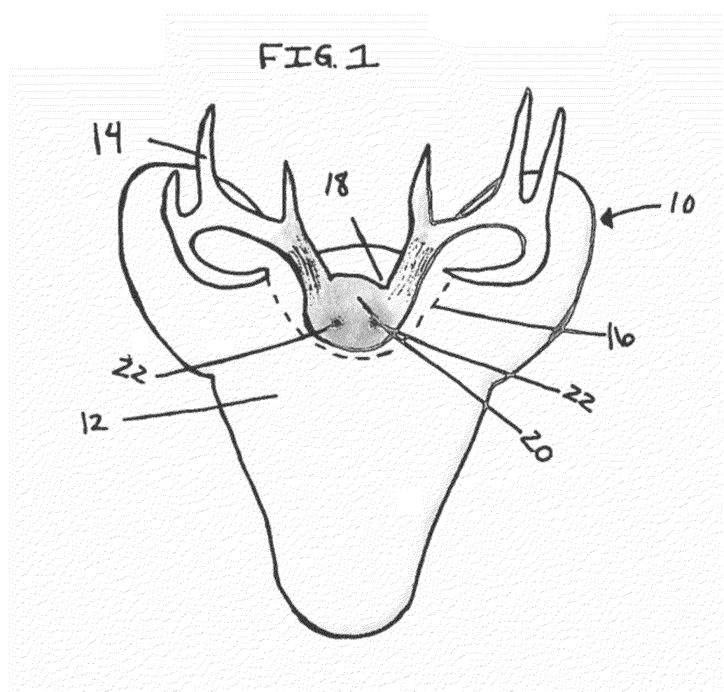

Referring to FIG. 1, an assembled deer antler mounting kit 10 of instant invention is shown, wherein the plaque component 12 thereof provides a display mount for affixment of antlers and skull cap 14 thereon by 2 screws 22, so that the same may be suitably and attractively positioned and supported upon a trophy room wall or the like. It will be noted that the plaque component 12 has the general shape and configuration of a deer head silhouette as would typically be seen from a full front view, so that the mountable affixment of the antlers and skull piece 14 are positioned in the same relative anatomical relationship as would appear on the live deer from which they came.

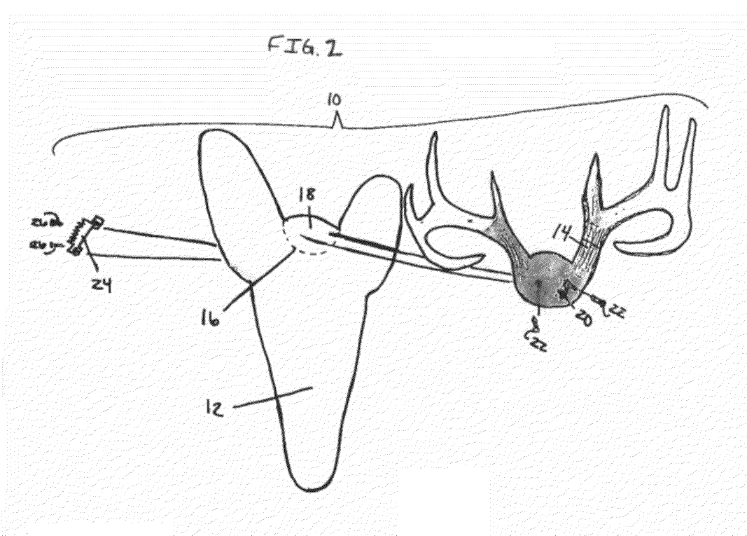

Referring now to FIG. 2 to explain in greater detail the user method for assembly of the deer antler mounting kit 10, and considering first the user assembly of the antlers and skull piece 14 to the plaque component 12 thereof. As can be seen more clearly in FIG. 2, the upper portion between the ears 16 of the plaque component 12 is provided within the forward facing side thereof with a flat receiving area 18 ready to receive and support the skull piece base 20 of the antlers and skull piece 14. Once the user manually orients and positions the antlers and skull piece 14 suitably within the flat area 18, then the user affixes the same by means of 2 screws 22 which are driven by the user through the scull piece base 20 and into the flat area 18 of the upper portion 16 of the plaque component 12 so that the antlers and skull piece 14 are thereby secured in a display position as previously shown in FIG. 1.

Lastly a wall hanging bracket 24 is assembled to the centrally intermediate upper back portion of the plaque 12, in a specific position determined by and dependent upon the antler size and weight and the balance thereof with respect to the plaque 12. It will be noted that the particular wall hanging bracket 24 which is illustrated is that type applied by means of 2 small screws 26, which is a wall hanging bracket system popularly employed in such applications, and is to be herein considered as exemplary only and not limiting.

The plaque component 12 as herein illustrated and described is preferably made of a suitable hardwood such as oak or the like, it may, however, be made form other materials such as plastics or the like.

Although the invention herein disclosed has been shown and described in what is conceived to be the most practical and preferred embodiment, it is recognized that departures may be made therefrom within the scope thereof, which is not to be limited to the specific details disclosed herein but is to be accorded the full scope of the claims so as to embrace any and all equivalent deer antler mounting kits adapted to be employed by an individual to affixably mount upon a provided plaque for display antlers and skull piece thereof.

I claim:

1. A deer antler mounting kit for mounting to display a pair of separate deer antlers comprising:
a structure defining a plaque having the configuration of a deer head silhouette as seen from a full frontal view of the head including the ears;
an upper central antler securing region on said plaque to respectively position the pair of separate deer antlers as they would have appeared on the live deer head from which they came;
components for mounting said pair of separate deer antlers respectively to the corresponding upper central antler securing region of the plaque; and
The pair of separate deer antlers which are still joined together by a small piece of skull are not included in the mounting kit but provided by others.

2. The deer antler mounting kit according to claim 1 wherein said plaque has affixed to the centrally intermediate rear portion thereof a wall hanging bracket:
The wall hanging bracket is attached to the plaque by two screws.

3. The deer antler mounting kit according to claim 1 wherein said plaque has securely affixed to it a pair of separate deer antlers;
The pair of separate deer antlers are affixed within the upper center front portion area, referred to in claim 1 as the upper central antler securing region by screws through the skull piece into the plaque.
